(19) United States
(12) Patent Application Publication
(10) Pub. No.: US 2008/0126671 A1
(43) Pub. Date: May 29, 2008

(54) NONVOLATILE MEMORY SYSTEM AND A METHOD OF CONTROLLING NONVOLATILE MEMORIES

(76) Inventor: Satoru Kashiwada, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/935,960

(22) Filed: Nov. 6, 2007

(30) Foreign Application Priority Data
Nov. 27, 2006 (JP) JP2006-318417

(51) Int. Cl. G06F 12/02

(52) U.S. Cl. 711/101; 711/E12.002

(57) ABSTRACT

A nonvolatile memory system having: a first nonvolatile memory in which data writing is limited to writing data on a per-sector basis; a second nonvolatile memory for storing a portion of data to be stored in the first memory; and a controller for controlling data read and write operations; wherein when the controller receives a write command for writing write data in the first memory, the controller writes the write data in the second memory linking to a write address specified by the write command under a condition that the same data as the write data designated to be written by the write command is not stored in a region in the first memory corresponding to the write address specified by the write command, and the controller performs a matching process, in which data in the second memory is moved in the first memory when a predetermined condition is satisfied.

### RELATED APPLICATION

This application is based on Japanese Patent Applications No. 2006-318417 filed with Japanese Patent Office on Nov. 27, 2006, the content of which is incorporated herein by reference.

### BACKGROUND

This invention relates to a nonvolatile memory system which uses nonvolatile memory and to a nonvolatile memory control method.

In devices such as multifunction peripherals which include document copying function, printing function, facsimile function and the like, data such as counter values which count device specific characteristic values, number of prints, number of copies and the like are generally stored in nonvolatile memory. Examples of various memory components for storing data in nonvolatile memory and their advantages and disadvantages will be given in the following.

(1) When volatile memory is backed up with a battery: a. reading, writing and random access are possible; b. there is a limit to the backup time due to the battery capacity when a battery is used; c. when SRAM (Static Random Access Memory) is used as the memory device, the bit price is high; d. when DRAM (Dynamic Random Access Memory) is used as the memory device, a control circuit for access to DRAM is required. Also when the power source is turned ON/OFF, a control circuit is required for switching to backup power.

(2) When using a flash memory in which the memory device itself is nonvolatile:

(2-1) When using NAND flash memory, a. the bit price is low and there is no limit to the backup time and batteries are not required; b. a dedicated access control circuit (sequencer) for changing the address when performing reading or writing or accessing data or for changing the flash internal memory address is required; c. at the time of data writing, address changes and erase operations in fixed capacity units (sector units) are required, and also a long processing time is required for the write operation; d. at the time of data reading, reading processing in a fixed capacity unit (usually 512 byte unit) is required, and the processing time required for reading suitably selected address data is longer than that of devices in which random access is possible such as SRAM and the like; e. a control circuit is required for blocking access to bad sectors because all the data in the flash memory is not secure; f. writing frequency is limited.

(2-2) When NOR flash memory is used, a. the bit price is low and there is no limit to the backup time and batteries are not required; b. at the time of data writing, access is done on a per-sector basis as is the case with NAND flash memory, but at the time of data reading, random access is possible; c. writing frequency is limited.

(3) When FeRAM (Ferroelectric RAM) is used as the nonvolatile memory, a data reading, writing and random access are possible and batteries are not required as is the case with SRAM. In addition, although there is a limit on writing frequency, it is in a range of 1 E to the 10^{th} power-1 E to the 12^{th} power and this is not problematic in terms of manufacturing dimensions; b. because the bit price is high, the cost of keeping all the nonvolatile parameters for multifunction peripherals in FeRAM is also high.

It is to be noted that data writing can only be done by sector units as in the case of flash memory, and in information processing devices using devices which require a long write processing time as the memory device, there is a cache memory control device which uses a cache memory that can reduce processing time for the data writing operation (Refer to Japanese Unexamined Patent Application No. 7-84886 for example). In this device, when data is written from the cache memory to the flash memory, the number of data that is stored in the cache memory is counted in flash memory block (sector) units and data writing from the cache memory to the flash memory is performed for the block in which the number of data stored in the cache memory is highest.

The device for nonvolatile data storage preferably satisfies the following conditions: no batteries are used; random access possible; there are no limits on practical writing frequency; and bit price is low. However, the prior art structures described above do not satisfy all these conditions. The cache memory control device disclosed in Japanese Unexamined Patent Application No. 7-84886 uses flash memory that has advantages that no batteries are required and bit price is low and it also achieves random write access and reduced processing time. However, when the power source is turned OFF, the data in the cache memory is lost.

### SUMMARY

According to one aspect of the present invention, a nonvolatile memory system is provided. The nonvolatile memory system comprises: a first nonvolatile memory in which data writing is limited to writing data on a per-sector basis; a second nonvolatile memory to which random access is possible and is for storing a portion of data to be stored in the first nonvolatile memory; and a controller for controlling data read and write operations for the first nonvolatile memory and the second nonvolatile memory; wherein when the controller receives a write command for writing write data in the first nonvolatile memory from an external device, the controller writes the write data in the second nonvolatile memory linking to a write address that was specified by the write command under a condition that the same data as the write data designated to be written by the write command is not stored in a region in the first nonvolatile memory corresponding to the write address specified by the write command, and the controller performs a matching process, in which data in the second nonvolatile memory is moved in the first nonvolatile memory on the per-sector basis when a predetermined condition is satisfied.

According to another aspect of the present invention, a nonvolatile memory system is provided. The nonvolatile memory system comprises: a first nonvolatile memory in which data writing is limited to writing data on a per-sector basis; a second nonvolatile memory to which random access is possible and is for storing a portion of data to be stored in the first nonvolatile memory; and a controller for controlling data read and write operations for the first nonvolatile memory and the second nonvolatile memory; wherein when the controller receives a write command for writing write data in the first nonvolatile memory from an external device, the controller writes the write data in the second nonvolatile memory linking to a write address that was specified by the write command under a condition that the same data as the write data designated to be written by the write command is not stored in a region in the first nonvolatile memory corresponding to the write address specified by the write command nor in a region in the second nonvolatile memory, and the controller performs a matching process, in which data in the second nonvolatile memory is moved in the first nonvolatile memory on the per-sector basis when a predetermined condition is satisfied.

According to yet another aspect of the present invention, there is provided a method of controlling memories including a first nonvolatile memory in which data writing is limited to writing data on a per-sector basis and a second nonvolatile memory to which random access is possible and is for storing a portion of data to be stored in the first nonvolatile memory, the method comprising: receiving a write command for writing write data in the first nonvolatile memory; writing the write data in the second nonvolatile memory linking to a write address that was specified by the write command under a condition that the same data as the write data designated to be written by the write command is not stored in a region in the first nonvolatile memory corresponding to the write address specified by the write command; and performing a matching process, in which data in the second nonvolatile memory is moved in the first nonvolatile memory on the per-sector basis when a predetermined condition is satisfied.

According to a further aspect of the present invention, there is provided a method of controlling memories including a first nonvolatile memory in which data writing is limited to writing data on a per-sector basis and a second nonvolatile memory to which random access is possible and is for storing a portion of data to be stored in the first nonvolatile memory, the method comprising: receiving a write command for writing write data in the first nonvolatile memory; writing the write data in the second nonvolatile memory linking to a write address that was specified by the write command under a condition that the same data as the write data designated to be written by the write command is not stored in a region in the first nonvolatile memory corresponding to the write address specified by the write command nor in a region in the second nonvolatile memory; and performing a matching process, in which data in the second nonvolatile memory is moved in the first nonvolatile memory on the per-sector basis when a predetermined condition is satisfied.

### BRIEF DESCRIPTION OF THE DRAWINGS

FIG. 1 is a block diagram showing the components of the nonvolatile memory system of a first embodiment of the present invention.

FIG. 2 is an explanatory diagram showing the write address WA that is assigned by the write command from the host, the write data WD and the relationship between the address and the data for the first FeRAM and the second FeRAM.

FIG. 3 is an explanatory diagram showing the operation of case 1 of the nonvolatile memory system of the first embodiment of the present invention.

FIG. 4 is an explanatory diagram showing the data changes in the operation of case 1 of the nonvolatile memory system of the first embodiment of the present invention

FIG. 5 is an explanatory diagram showing the operation of case 2 of the nonvolatile memory system of the first embodiment of the present invention.

FIG. 6 is an explanatory diagram showing the data change in the operation of case 2 of the nonvolatile memory system of the first embodiment of the present invention.

FIG. 7 is an explanatory diagram showing the operation continued from FIG. 5.

FIG. 8 is an explanatory diagram showing the data change continued from FIG. 6.

FIG. 9 is an explanatory diagram showing the operation of case 3 of the nonvolatile memory system of the first embodiment of the present invention.

FIG. 10 is an explanatory diagram showing the data change in the operation of case 3 of the nonvolatile memory system of the first embodiment of the present invention.

FIG. 11 is an explanatory diagram showing the operation of case 4 of the nonvolatile memory system of the first embodiment of the present invention.

FIG. 12 is an explanatory diagram showing the data changes in the operation of case 4 of the nonvolatile memory system of the first embodiment of the present invention.

FIG. 13 is an explanatory diagram showing the operation of the nonvolatile memory system that received the read command from the host (when the data read from the first nonvolatile memory is output to the host).

FIG. 14 is an explanatory diagram showing the operation of the nonvolatile memory system that received the read command from the host (when the data read from the second nonvolatile memory is output to the host).

FIG. 15 is an explanatory diagram showing the matching process performed by the nonvolatile memory system of the first embodiment of the present invention.

FIG. 16 is a block diagram showing the components of the nonvolatile memory system of a second embodiment of the present invention.

FIG. 17 is an explanatory diagram showing the conversion table and address conversion in the case where all sector numbers prior to conversion match the sector numbers after conversion.

FIG. 18 is an explanatory diagram showing the case where the address conversion is done such that sector 2 and sector 15 are switched.

FIG. 19 is an explanatory diagram showing an example of the operation of the nonvolatile memory system of the second embodiment of the present invention.

FIG. 20 is an explanatory diagram showing the data change in the operation shown in FIG. 19.

FIG. 21 is an explanatory diagram showing the operation continued from FIG. 19.

FIG. 22 is an explanatory diagram showing the data changes continued from FIG. 21.

### DETAILED DESCRIPTION OF THE PREFERRED EMBODIMENTS

The following is a description of each of the embodiments of the present invention based on the drawings.

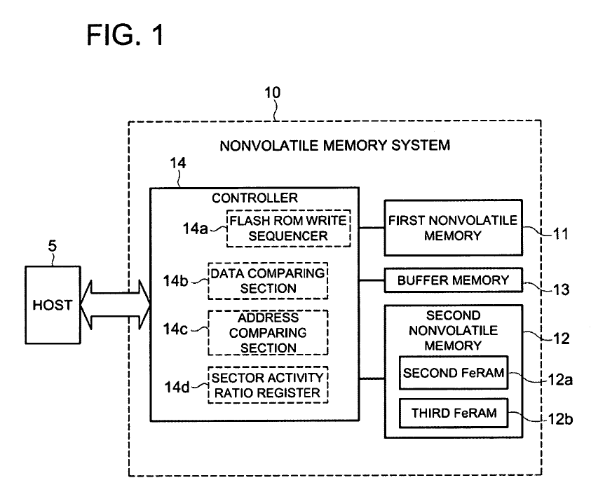

FIG. 1 shows the components of the nonvolatile memory system 10 of the first embodiment of the present invention. The nonvolatile memory system 10 is connected to a host 5 which comprises an information processing device which includes the CPU (Central Processing Unit), and the read/write operation of the data for the internal memory is performed based on a read command or a write command from the host 5.

The nonvolatile memory system 10 comprises a first nonvolatile memory 11 in which the data writing is limited to writing data on a per-sector basis; a second nonvolatile memory 12 in which random access is possible and which is for storing a portion of the data stored in the first nonvolatile memory 11; a buffer memory 13 that is used when writing data in the first nonvolatile memory 11; and a controller 14 for controlling data read and write operations for the memories 11, 12 and 13.

The first nonvolatile memory 11 is the main memory in the nonvolatile memory system 10, and a NOR flash memory is used here. In the NOR flash memory, data erasing and writing are limited to writing data on a per-sector basis. The NOR flash memory is nonvolatile memory in which random access data reading for each address is possible. The first nonvolatile memory 11 has an address length of 20 bits, data width of 8 bits, and a capacity of 1 MB (megabytes), and the NOR flash memory has a sector size which is the writing unit of 64 KB (kilobytes) and the number of sectors is 16.

The second nonvolatile memory 12 is memory for storing a portion of the data stored in the first nonvolatile memory 11 rather than in the first nonvolatile memory 11, and it also links the data with the storage address (write address) in the first nonvolatile memory 11 and stores them. The capacity of the second nonvolatile memory 12 is less than that of the first nonvolatile memory 11.

FeRAM is used as the second nonvolatile memory 12 herein. The second nonvolatile memory 12 comprises two memory elements which are the first FeRAM 12a for saving data and the second FeRAM 12b for saving the write address. FeRAM having address length of 13 bits, data length of 8 bits, and capacity of 4 KB are used as the first FeRAM 12a and the second FeRAM 12B respectively.

The buffer memory 13 is nonvolatile memory having a capacity for more than one sector of the first nonvolatile memory 11. FeRAM having address length of 16 bits, data length of 8 bits, and capacity of 64 KB is used as the buffer memory 13.

The controller 14 functions as the flash ROM writing sequencer 14a, the data comparing section 14b, the address comparing section 14c, the sector activity ratio register 14d and the like. The flash ROM writing sequencer 14a controls the processes which carry out the write commands and the read commands from the host 5. The controller 14 comprises an ASIC (Application Specific Integrated Circuit).

The data comparing section 14b is used for comparing the write data for the write command from the host 5 with the read data from the first nonvolatile memory 11. The address comparing section 14c is used for comparing the write address specified by the write command from the host 5 with the address information stored in the first FeRAM 12a, and the like.

The sector activity ratio register 14d is provided in each sector of the first nonvolatile memory 11 and is a register for storing the activity ratio of the second nonvolatile memory 12 for each sector unit of the first nonvolatile memory 11. The activity ratio herein is the number of active data that is stored in the second nonvolatile memory 12 and it is stored in the sector activity ratio register 14d.

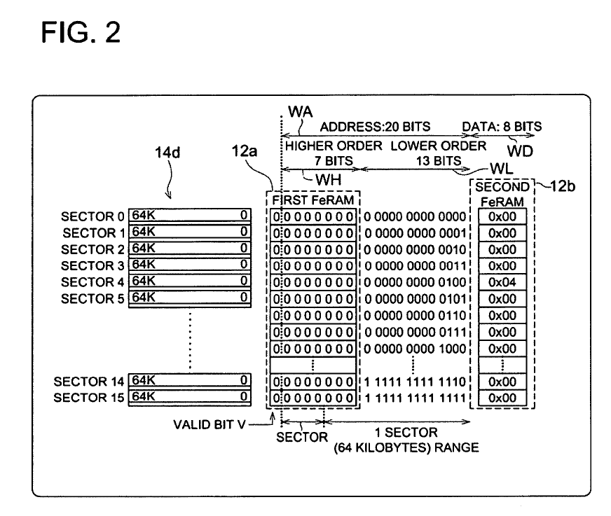

FIG. 2 shows the write address WA that is assigned by the write command from the host 5, the write data WD as well as the relationship between the address and the data for the first FeRAM 12a and the second FeRAM 12b.

The 20 bit write address WA from the host 5 and the 8 bit write data WD are assigned in the write command. The lower order 13 bits WL of the 20 bit write address WA are used as the access address for the first FeRAM 12a and the second FeRAM 12b. The first 7 bits of the address WH is stored in the first FeRAM 12a, while the write data WD is stored in the second FeRAM 12b.

The value of address WH which is the first 7 bits of the write address WA is stored in the lower order 6 bits of the data stored in the first FeRAM 12a and the most significant bit of the data stored in the first FeRAM 12a used as the valid bit V which has a value of “1” when the data stored in the first FeRAM 12a and the second FeRAM 12b is valid and a value of “0” when it is invalid.

The higher-order 4 bits of the address WH stored in the first FeRAM 12a indicates the sector number of the first nonvolatile memory 11. The sector activity ratio register 14d is prepared for each 16 sector and is used for managing and for storing the number of the valid data (data where the valid bit V is set to “1”) stored in the first FeRAM 12a and the second FeRAM 12b for each sector. When the controller 14 sets the valid bit V to “1”, sets the value of the corresponding sector activity ratio register 14d to “+1” and resets the valid bit V to “0”, the value of the sector activity ratio register 14d corresponding to the sector containing the data is “−1”.

Next, the operation of the nonvolatile memory system 10 when the write command is received from the host 5 will be described.

The write command from the host 5 is retrieved by random access and the controller 14 assigns the write address WA that is specified by the write command to the first nonvolatile memory 11 as the access address and the data RD from the first nonvolatile memory 11 is read and the data RD is compared with the write data for the write command from the host 5 in the data comparing section 14b. The operations are described for each case in the following.

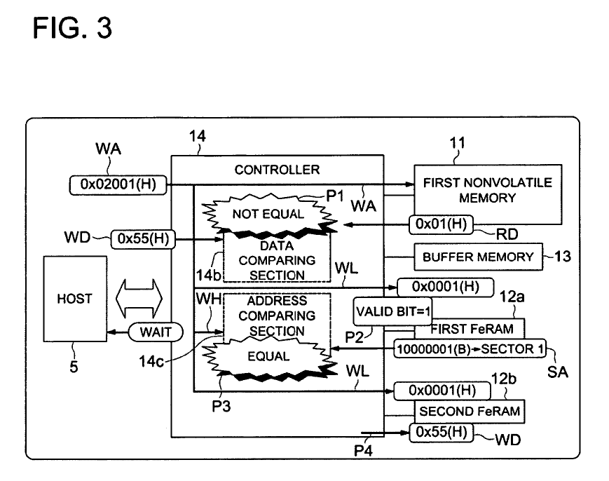

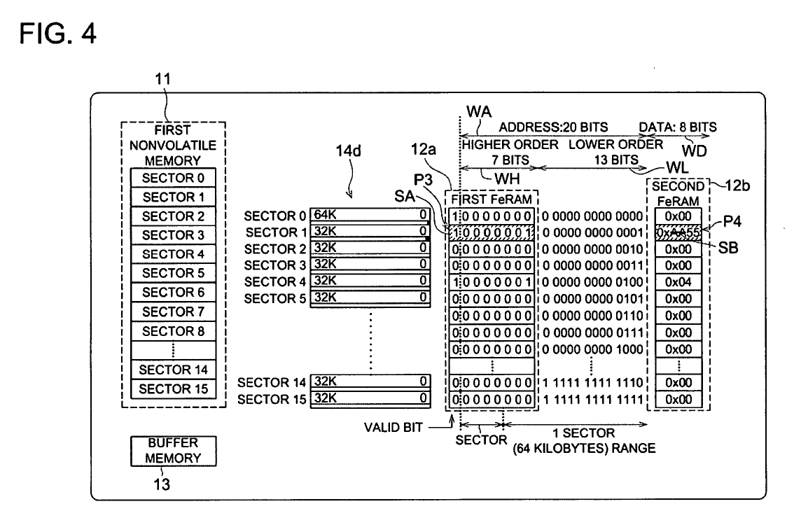

### <Case 1: Refer to FIG. 3 and FIG. 4>

This is the case where: the read data RD from the first nonvolatile memory 11 and the write data WD from the host 5 are not the same (P1); the address WL which is the lower order 13 bits of the write address WA from the host 5 is used as the address value, and the valid bit V in the data SA that is read from the first FeRAM 12a is “1” (valid) (P2); the 20 bit address in which the address value of the higher-order 7 bits included in the data SA is used as the first portion and combined with the lower order 13 bits of the write address WA, is the same as the write address WA (P3). That is to say, this is the case where data which the same as the write data WD is not linked to the write address WA and not stored in the first nonvolatile memory 11, and the valid data that is linked to the write address WA is stored in the second nonvolatile memory 12.

In this case, the data SB in the region in the second FeRAM 12b which has the address WL which is the lower order 13 bits of the write address WA as the address value (Refer to FIG. 4) is rewritten to the write data WD for the write command from the host 5 (P4). That is to say, write data WD which has been linked to the write address WA is written into the second nonvolatile memory 12.

In the example shown in FIG. 3 and FIG. 4, the write address WA is 0 x 020001 (H) (H indicates the hexadecimal notation); the write data WD is 0 x 55(H); the read data RD from the first nonvolatile memory 11 is 0 x 01 (H); and data SA is 10000001 (B) (B indicates binary notation). Thus, data RD (0 x 01(H)) and the write data WD 0 x 55(H) are not the same; the valid bit V is “1” (valid); and the 20 bit address in which the address value of the higher-order 7 bits included in the data SA is combined with the address WL which is the lower order 13 bits of the write address WA is the same as the write address WA. Thus the data SB (0x AA (H)) in the second FeRAM 12b is rewritten to 0 x 55(H) which is the write data WD (P4).

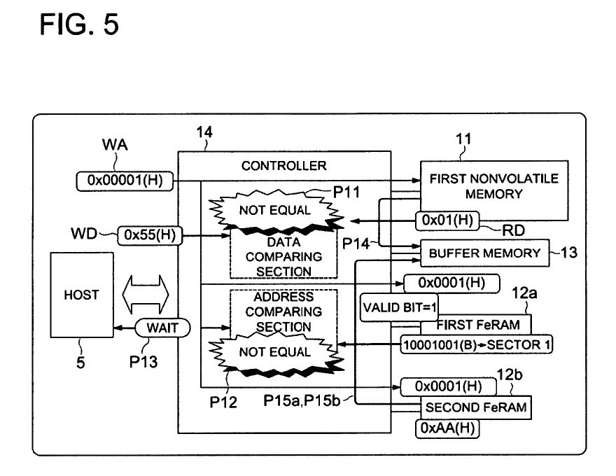

### <Case 2: Refer to FIG. 5 to FIG. 8>

This is the case where: the data RD read from the first nonvolatile memory 11 and the write data WD from the host 5 are not the same (P11); the valid bit V, in the data SA that has the lower order 13 bits of the write address WA as the address value and which is read from the first FeRAM 12a, is “1”; and the 20 bit address in which the address value of the higher-order 7 bits included in the data SA is combined with the lower order 13 bits of the address WL of the write address WA is the not same as the write address WA (P12).

In this case, in order to create an empty region for writing the write data WD in the second FeRAM 12b, the matching process for writing the data in the second FeRAM 12b on a per-sector basis to the relevant sector in the first nonvolatile memory 11 is performed and subsequently, the write data WD is written into the second FeRAM 12b.

That is to say, while the WAIT signal is output to the host 5 (P13), all the data in the sector which shows the sector number in the data SA is read from the first nonvolatile memory 11 and copied to the buffer memory 13 (P14). Next all 16 bits formed by combining the upper address which is the lower order 3 bits of the address value of the higher-order 7 bits included in the data SA and the lower order 13 bits of the write address WA is used as the address and the buffer memory 13 is accessed for writing, and data SB is written into the buffer memory 13 (P15a).

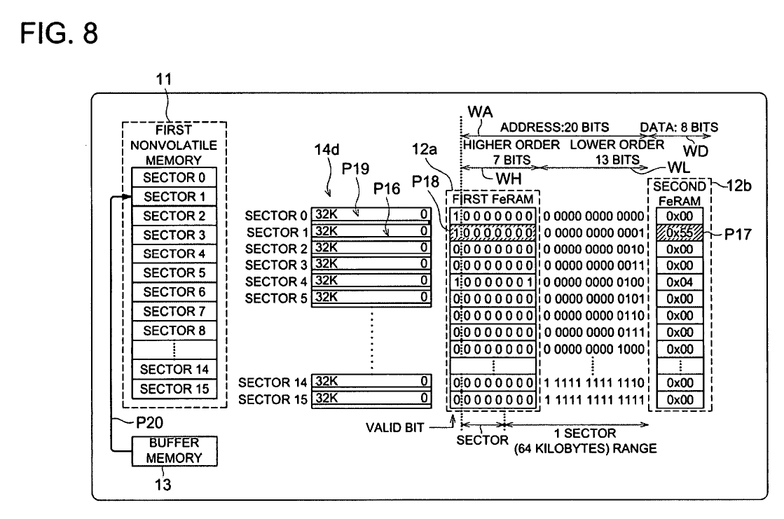

Furthermore, of the data stored in second FeRAM 12b, the data SC in which the valid bit V is “1”, and which is linked to the sector which has the same sector number as that in the data SA (valid data) are respectively copied to the corresponding region in the buffer memory 13 (P15b). The valid bit V corresponding to the copied data SB and SC is set to “0” (invalid) and the value of the sector activity register 14d corresponding to the sector number in the data SA is reduced by the data number for which the valid bit V has been changed or reset to “0” (FIG. 8: P16).

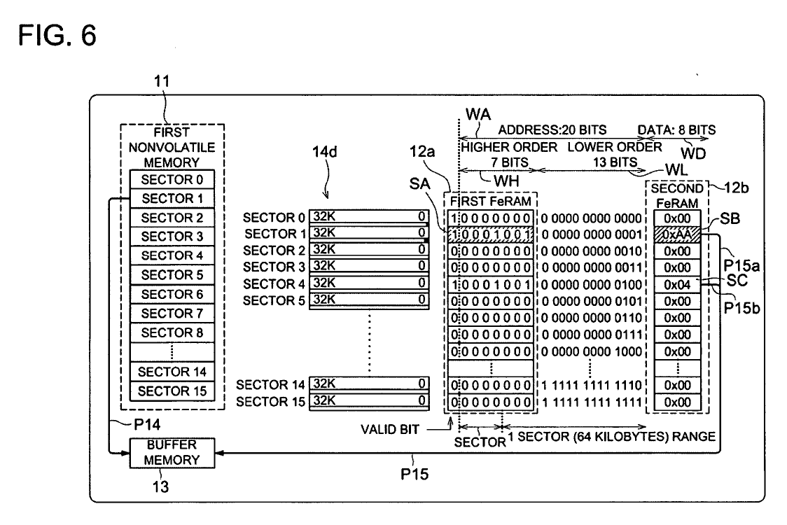

More specifically, the following processes are carried out for each address value in the address range of the 13 bits assigned to the first FeRAM 12a and the second FeRAM 12b. In the case where the valid bit V of the data SC read from the first FeRAM 12a is “1” and the sector number in the data is the same as the sector number in the data SA, the valid bit V for this SC data is rewritten to “0” and the lower order 3 bits of the data SC is the upper address and to this is added the 13 bit address assigned to the first FeRAM 12a and the second FeRAM 12b to give a 16 bit value and this is used as the address value and the buffer memory 13 is accessed for writing and the data SC that is read from the second FeRAM 12b is written into the buffer memory 13 (FIG. 6: P15).

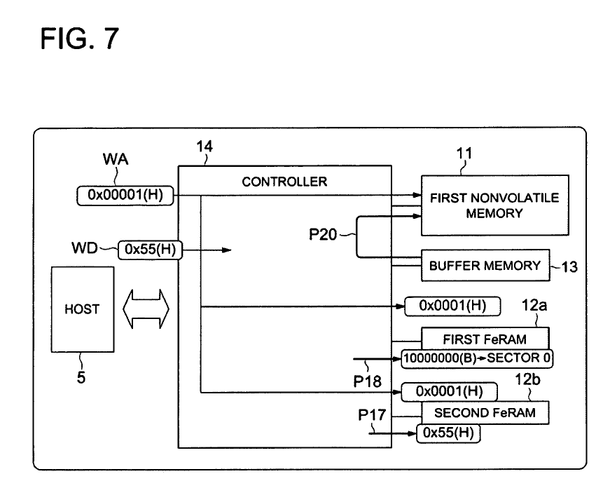

Next, the data SB in the second FeRAM 12b is rewritten to the write data WD (FIG. 7 and FIG. 8, P17) and the data which includes the higher-order 7 bits of the write address WA from the host 5 in the region having the data SA and in which the valid bit V is “1” (P18), is written in the first FeRAM 12a. In addition, the sector activity ratio register 14d corresponding to the sector included in this data is set “+1” (P19).

In this manner, the write data WD is linked to the write address WA (20 bit address in which all of the 13 bits assigned to the first FeRAM 12a and second FeRAM 12b and the higher-order 7 bits stored in the first FeRAM 12a) and stored in the second nonvolatile memory 12 (12a and 12b). Subsequently, the WAIT signal to the host 5 is cancelled and the relevant sector in the first nonvolatile memory 11 (sector in which data is read in the buffer memory 13 in P14) is erased and data for one sector created in buffer memory 13 is written in the corresponding sector in the first nonvolatile memory 11 (P20) and the series of processes corresponding to the write command ends.

In the examples in FIG. 5 to FIG. 8, the write address WA is 0 x 00001 (H); the write data WD is 0 x 55(H); the data RD read from the first nonvolatile memory 11 is 0 x 01 (H); data SA is 10001001 (B); and data RD (0 x 01H) and the write data WD (0 x 55H) are not the same, and the 20 bit address (0 x 12001H) in which the address value of the higher-order 7 bits included in the data SA in which the valid bit V of data SA is “1”, is combined with the address WL which is the lower order 13 bits of the write address WA is not the same as the write address WA (0 x 00001H).

Thus, because the sector number included in data SA is “1”, the data SB (0 x AA) (H)) and data SC (0 x 04 (H)) which is in the same sector 1 as data SC is copied from the second FeRAM 12b to the first nonvolatile memory 11 (FIG. 6: P14, P15a and P15b and FIG. 8: P20). The valid bit V for the relevant data is set to “0” and furthermore the value for the sector activity ratio register 14d corresponding to the sector 1 is reset to “0” (FIG. 8: P16) and the data SB in the second FeRAM 12b (0 x AA) (H) is rewritten with write data WD (0 x 55(H)) (P17) and also data SA is rewritten with 10000000 (B)(P18) and the value for the sector activity ratio register 14d corresponding to the sector 0 is “+1” (P19).

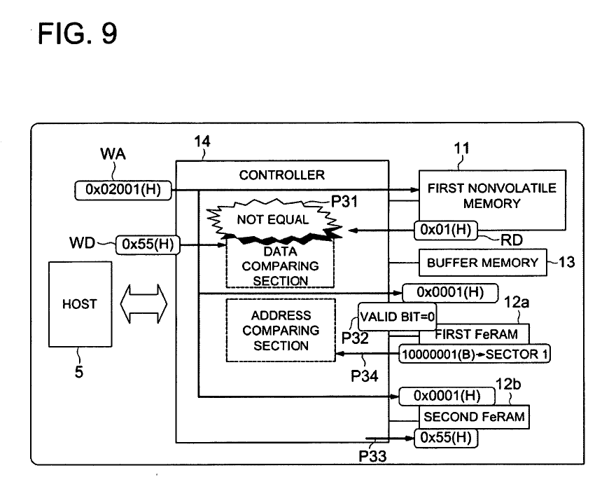

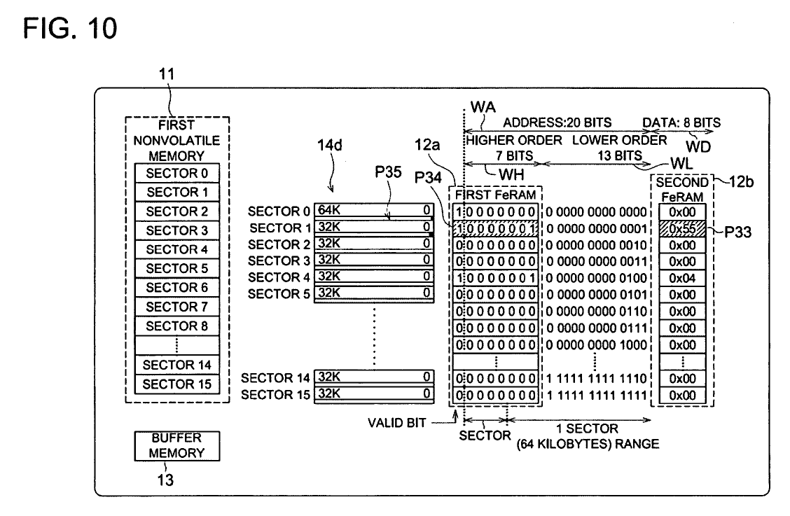

### <Case 3: See FIG. 9 and FIG. 10>

This is the case where read data RD from the first nonvolatile memory 11 and the write data WD from the host 5 are not the same (P31); and the lower order 13 bits of the write address WA is used as the address value and the valid bit V in the data SA read from the first FeRAM 12a is “0” (P32).

In this case, data SB in the second FeRAM 12b is rewritten with the write data WD (P33) and data which includes the higher-order 7 bits of the write address WA and in which the valid bit V is “1”), is written from the host 5 into the region having the data SA in the first FeRAM 12a (P34). In addition, the sector activity ratio register 14d corresponding to the sector included in this data is set to “+1” (FIG. 10: P35).

In the example shown in FIG. 9 and FIG. 10, the write address WA is 0 x 02001 (H); the write data WD is 0 x 55(H); the data RD read from the first nonvolatile memory 11 is 0 x 01 (H); and data RD (0 x 01(H)) and the write data WD (0 x 55(H)) are not the same (P31) and the valid bit V of data SA is “0” (P32). Thus, the data SB is re-written to 0 x 55 (H) which is the write data WD (P33) and 10000001 is written into the region having the data SA (P34) and value of the sector activity ratio register 14d for sector 0 is “+1” (P35).

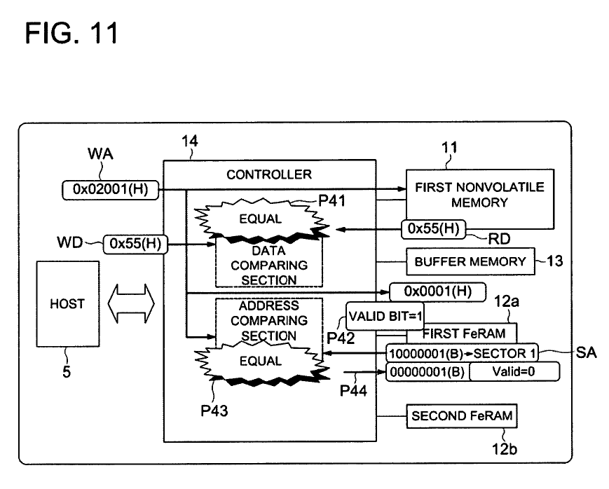

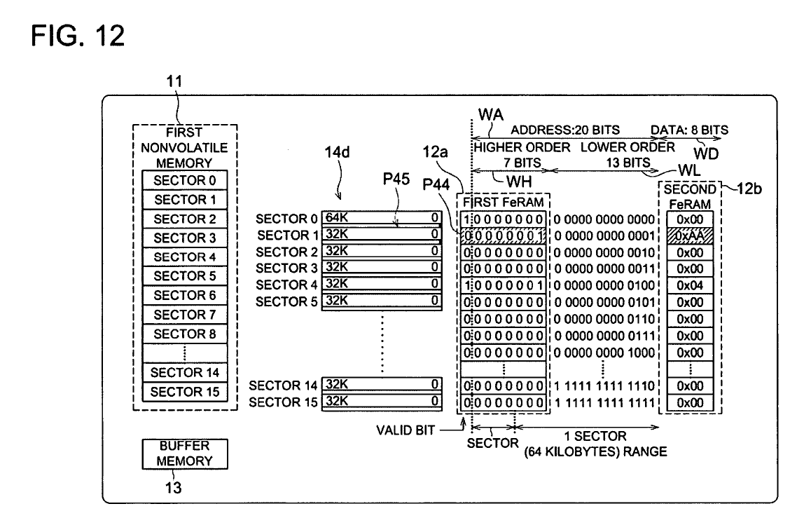

### <Case 4: See FIG. 11 and FIG. 12>

This is the case where the read data RD from the first nonvolatile memory 11 and the write data WD from the host 5 are the same (P41); the valid bit V that has the lower order 13 bits of the write address WA as the address value and is in the data SA that is read from the first FeRAM 12a is “1” (P42) and the 20 bit address in which the address value of the higher-order 7 bits included in the data SA is combined with the address WL which is the lower order 13 bits of the write address WA is the same as the write address WA (P43).

In this case, the data SA is rewritten to a value in which the valid bit V is cleared to “0” (P44). In addition, the value of the sector activity ratio register 14d corresponding to the sector number included in this data SA becomes “−1” (FIG. 12: P45). That is to say, the valid data that is linked to the write address WA is also present in the first nonvolatile memory 11 and the second nonvolatile memory 12 and thus the data at the second nonvolatile memory 12 side is invalid.

In the example shown in FIG. 11 and FIG. 12, the write address WA is 0 x 02001 (H); the write data WD is 0 x 55(H); and the read data RD from the first nonvolatile memory 11 is 0 x 55(H); and the data RD (0 x 55(H)) and the write data WD (0 x 55(H)) are the same (P41); and the valid bit V of data SA is “1” (P42). The valid bit V of data SA is reset to “0” (P44) and value of the sector activity ratio register 14d for sector 0 is “−1” (P45).

In this case, the same data as the write data WD is stored in the first nonvolatile memory 11, and thus the write data WD is not written to any of the first nonvolatile memory 11 and the second nonvolatile memory 12. In addition, because the valid data SB is linked to the write address WA and stored in the second FeRAM 12b, it is invalid. For example, when 0 x 55 (H) is stored in a region in the first nonvolatile memory 11 corresponding to the write address WA, 0 x AA (H) is written as the write data WD, and the write data WD (0 x AA (H)) is stored in the second FeRAM12b and then if 0 x 55 (H) which is the original value is written as the write data WD, this becomes the operation of case 4.

### <Case 5>

This is the case where: the read data RD from the first nonvolatile memory 11 and the write data WD from the host 5 are the same; the valid bit V that has the lower order 13 bits of the write address WA as the address value and is in the data SA that is read from the first FeRAM 12a is “1”; and the 20 bit address in which the address value of the higher-order 7 bits included in the data SA is combined with the address WL which is the lower order 13 bits of the write address WA is the not same as the write address WA.

In this case, the process ends without data being rewritten in any of the first nonvolatile memory 11, the first FeRAM 12a, and the second FeRAM 12b. That is to say, the same data as the write data WD is stored in the first nonvolatile memory 11, and thus the write data WD is not written to any of the first nonvolatile memory 11 and the second nonvolatile memory 12. In addition, because the valid data which is linked to the write address WA and not stored in the second FeRAM 12b, data is not re-written in the first FeRAM 12a and the second FeRAM 12b.

### <Case 6>

This is the case where: the read data RD from the first nonvolatile memory 11 and the write data WD from the host 5 are the same and the valid bit V that has the lower order 13 bits of the write address WA as the address value and is in the data SA that is read from the first FeRAM 12a is “0”. In this case, the process ends without data being rewritten in any of the first nonvolatile memory 11, the first FeRAM 12a, the second FeRAM 12b. That is to say, as is the case in Case 5, the same data as the write data WD is stored in the first nonvolatile memory 11, and thus the write data WD is not written to any of the first nonvolatile memory 11 and the second nonvolatile memory 12. In addition, because no valid data that is linked to the write address WA is stored in the second FeRAM 12b, data is not re-written in the first FeRAM 12a and the second FeRAM 12b.

Next, the operation of the nonvolatile memory system 10 in the case where a read command is received from the host 5 will be described.

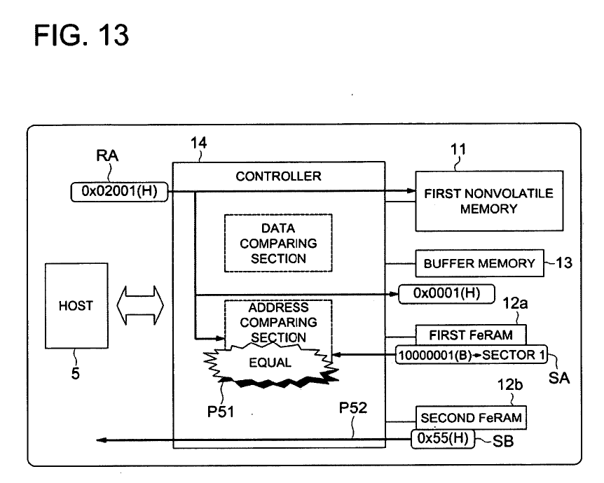

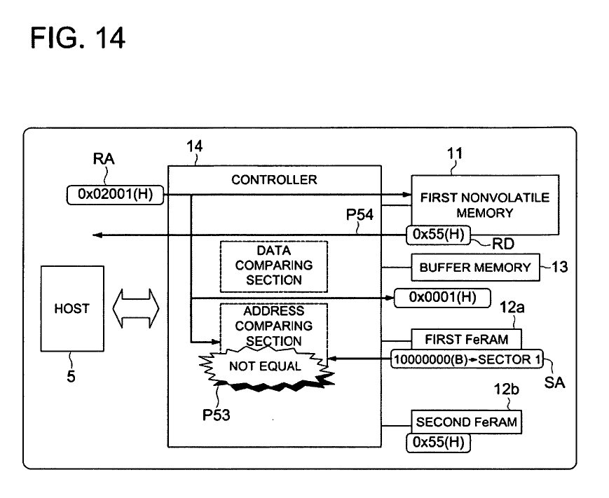

The read command from the host 5 is retrieved by random access and the controller 14 compares the read address RA from the host 5 with the effective address value that is stored in the first FeRAM 12a, or in other words the address value of the 20 bit address in which the lower order 13 bits of the read address RA is assigned as the address value and the 7 bit address value included in data SA read from the first FeRAM 12a is assigned as the upper address and the lower order 13 bits of the read address RA is combined with the 7 bit address value. In the case where they are the same (FIG. 13, P51), the lower order 13 bits of the read address RA is used as the address value and the data SB read from the second FeRAM 12b is output to the host 5 (P52). In the case where they are not the same (FIG. 14: P53), the read address RA is used as the address value and the read data RD from the first nonvolatile memory 11 is output to the host 5 (P54).

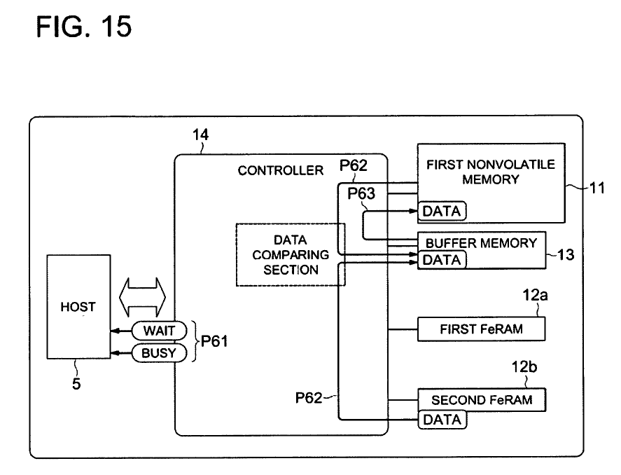

Next, the matching process for writing valid data in the second FeRAM 12b on a per-sector basis to the first nonvolatile memory 11 is described based on FIG. 15.

The matching process is performed when predetermined start up conditions are met. In the matching process, the controller 14 outputs a busy signal which indicates that access to the nonvolatile memory system 10 is impossible or alternatively outputs a WAIT signal for access from the host 5 (P61) while performing the following processes for the target sector. First, the data in the target sector in the first nonvolatile memory 11 is matched with the data stored in second nonvolatile memory 12 while temporarily copying the data to buffer memory 13 (P62). Next, the target data in the first nonvolatile memory 11 is erased and data for one sector that was previously created in the buffer memory is written into the target sector in the first nonvolatile memory 11 (P63).

Specifically, when the data in the target sector is successively read from the first nonvolatile memory 11, the lower order 16 bits of the 20 bit address assigned to the first nonvolatile memory 11 is assigned to the buffer memory 13 as the address value. In addition, the lower order 13 bits of the 20 bit address is assigned to the first FeRAM 12a and the second FeRAM12b, and in the case where the valid bit V for the data read from the first FeRAM 12a is “1” and the 7 bit address included in the data is the same as the higher-order 7 bits of the of the address assigned to the first nonvolatile memory 11, the data read from the second FeRAM12b is written in the buffer memory 13, and in the other case, the data read from the first nonvolatile memory 11 is written in the buffer memory 13. In addition, at the end of the matching process, the value for the sector activity ratio register 14 for the sector to undergo the matching processing is reset to “0”.

The prescribed start up condition which allows execution of this type matching processing are satisfied when for example, the value shown by the sector activity ratio register 14d of total activity ratio for all the sectors exceed a threshold value, or when the total activity ratio is 100 percent. If the threshold value is set to be less than 100 percent, the second nonvolatile memory 12 never becomes full and occurrence of the case where the matching process for securing an empty region for writing the write data WD in the second nonvolatile memory 12 starts up at the point when the write command from the host 5 is received, is reduced. Also cases of host 5 waiting for the write command is reduced and thus the data writing process can be carried out smoothly.

It is to be noted that in the case where the total activity ratio exceeds the threshold value, the sectors that are to be subjected to matching processing can be suitably selected, but if the sectors that have a large number of valid data in the second FeRAM12b are preferentially selected, the total activity ratio can be effectively reduced in a single matching process. In addition, when the predetermined startup conditions are met, the number of sectors to be subjected to the matching process is not limited to one. For example, the matching process can be performed for a suitably selected number of sectors until the total activity ratio is less than a prescribed value.

In addition to this, the predetermined startup conditions are met in the case where there is no empty region in the second nonvolatile memory 12 for writing write data WD when the write command is received. That is to say the matching process is also performed in Case 2 above.

Furthermore, matching processing may be performed for the sectors in which the activity ratio stored in the sector activity ratio register 14d exceeds the threshold value.

If the threshold for the activity ratio or the total activity ratio is set to be large, the start up frequency of the matching process using threshold value as the standard decreased, but as in Case 2 above, because there is a high possibility that the matching process will be performed when the write command is executed, consideration must be given to balance between these factors when setting the threshold value.

As described above, in the nonvolatile memory system 10 of the first embodiment, by using the NOR flash memory which has low bit price as the main memory device (first nonvolatile memory 11) and FeRAM (second nonvolatile memory 12) as the auxiliary memory device, random access data reading and writing is possible and the limit on writing frequency is relaxed, and also batteries are not used and unlimited data storage becomes possible.

That is to say, the NOR flash memory in which data writing is performed on a per-sector basis is the first nonvolatile memory 11 and the FeRAM in which random access is possible is the second nonvolatile memory 12, and given the condition that the same data as the write data WD is not stored in the region in the first nonvolatile memory 11 corresponding to the write address WA specified by the write command, the write data WD is linked to the write address WA and stored in the second nonvolatile memory 12, and thus NOR flash memory which has low bit price is used as the main memory device while random access data writing from the host 5 is possible.

In addition, the matching process in which the data stored in the second nonvolatile memory 12 is moved to the first nonvolatile memory 11 is performed on a per-sector basis when the predetermined start up conditions hold and thus random access data writing is possible and also the data writing frequency for the first nonvolatile is reduced and control of the writing frequency is relaxed.

In this embodiment, write data is linked to the write address and written into the second nonvolatile memory under the condition that the data which is the same as the write data is stored in a region in the first nonvolatile memory indicated by the write address. In addition, when the prescribed conditions hold, the data in the second nonvolatile memory is written on a per-sector basis to the first nonvolatile memory. The writing of the write data for the write command is done in second nonvolatile memory in which random access is possible and thus random access writing operation is ensured. In addition, the matching process for moving the data that is written in the second nonvolatile memory to the first nonvolatile memory is performed on a per-sector basis and thus the writing frequency for the first nonvolatile memory is less than that in the case where data is directly written in the first nonvolatile memory for each write command.

In addition, in the case where data which is the same as the write data is already present in the first nonvolatile memory, writing of the write data in the second nonvolatile memory is not performed as well and thus the frequency of writing in the second nonvolatile memory is reduced and data that is already present in the first nonvolatile memory is no longer stored again in the second nonvolatile memory, and the storage region in the second nonvolatile memory is used effectively and the frequency of the matching process for securing empty regions is also reduced. This contributes to reduction of the writing frequency in the first nonvolatile memory and improved processing speed.

Next the second embodiment of this invention will be described.

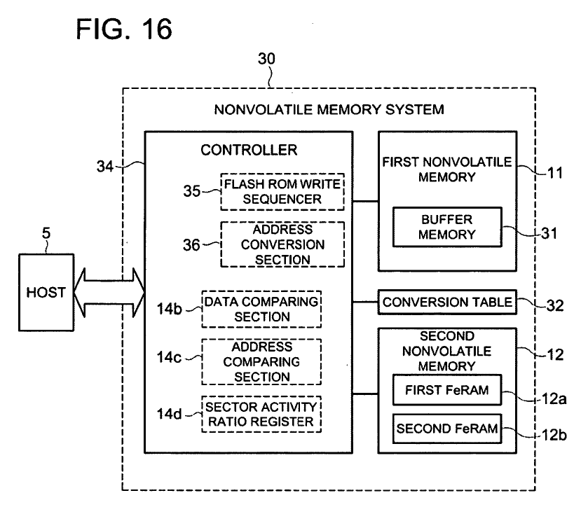

FIG. 16 shows the components of the nonvolatile memory system 30 of the second embodiment. In the nonvolatile memory system 30 of the second embodiment, the memory region equivalent to the buffer memory 13 that is provided independently in the first working example is secured in the first nonvolatile memory 11. Otherwise, the nonvolatile memory system 10 is the same as that of the first embodiment and those parts that are the same as that of the first embodiment has been assigned the same reference numbers and descriptions thereof have been omitted.

In the nonvolatile memory system 30, one sector in the first nonvolatile memory 11 which is NOR flash memory is used as the buffer memory. The controller 34 allocates the region other than the one sector region to be used as the buffer memory and which can be accessed from the host 5. The controller 34 has an address converter 36 for dynamically switching the region assigned to the buffer memory 31. The flash ROM writing sequencer 35 converts addresses using the address converter 36 while performing control for the write commands and read commands received from the host 5.

The conversion table 32 is rewritable nonvolatile memory in which the address conversion information used in the address conversion section 36 is stored and it is connected to the controller 34. The conversion table 32 may be allocated to a part of the region in the second nonvolatile memory 12 or a separate memory element may be provided.

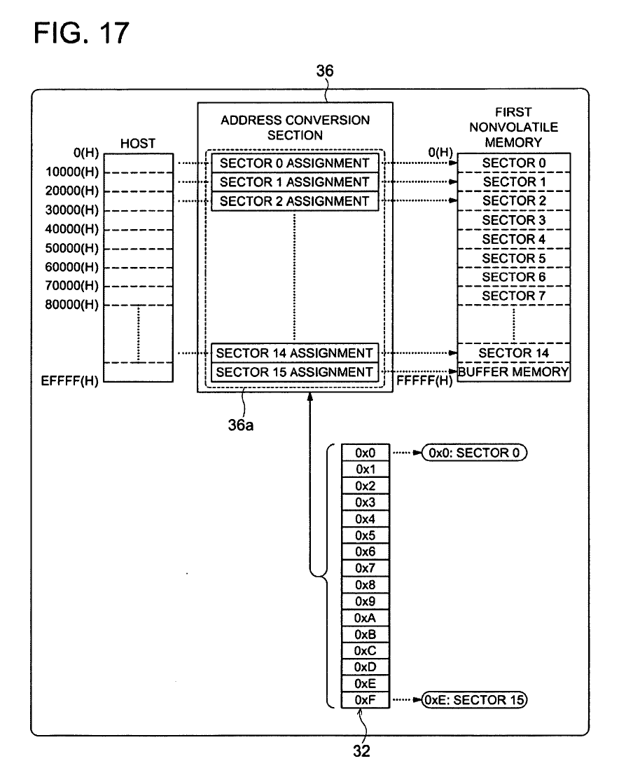

The conversion table 32 stores information which shows the relationship between the pre-conversion sector number and the post-conversion sector number. The conversion table 32 shown in FIG. 17 stores the post-conversion sector number as the table value in the order of the pre-conversion sector number from the top of the table. The controller 34 reads the content of the conversion table 32 into the address conversion register 36a provided in the address conversion section 36 and address conversion is performed by referring to the address conversion register 36a.

In this example, there are 16 sectors and the sector number is indicated by 4 bits. The address conversion section 36 assigns the higher-order four bits of the address from the host 5 to the address conversion register 36a as the pre-conversion sector number, and the post-conversion sector number is obtained from the address conversion register 36a and the obtained post-conversion sector number is substituted by the higher-order four bits of the address assigned to the first nonvolatile memory 11 and then output.

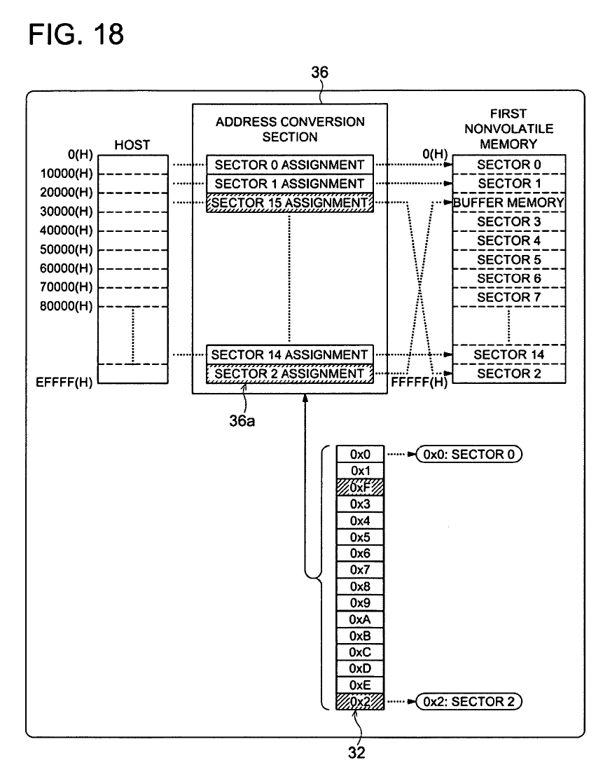

FIG. 17 shows an example of the case in which the all the pre-conversion sector numbers and the post-conversion sector numbers are equal and FIG. 18 shows an example of the case where the address is changed such that sector 2 and sector 15 are substituted. In the example of FIG. 18, when the address from the host 5 is 0 x 20000 (H) (sector number 2), the sector number output from the address conversion sector 36 is 0 x 0F (H) and all together the address 0 x F0000 (H) is output to the first nonvolatile memory 11.

Next, the operation of the nonvolatile memory system 30 in the case where the buffer memory 31 is used will be described.

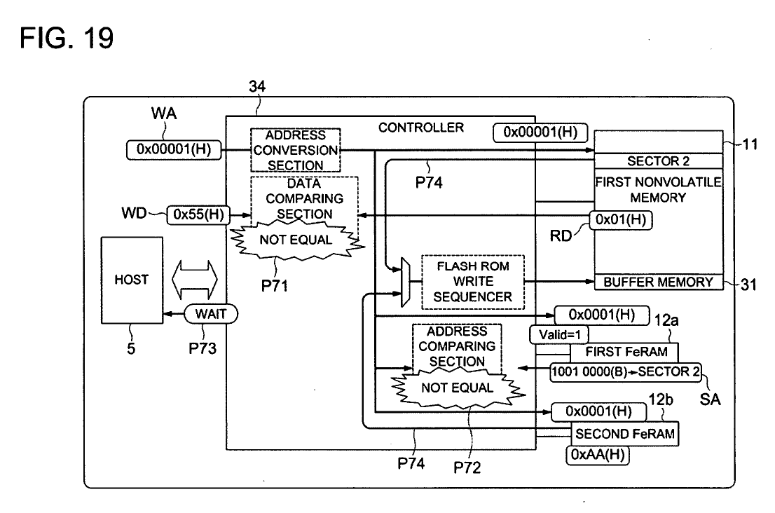

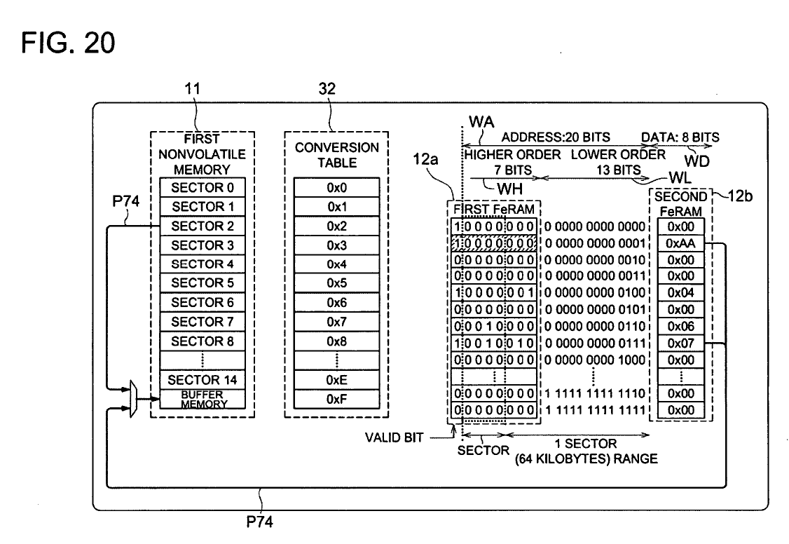

This case will be described based on FIG. 19-FIG. 22. In the case 2 as described above, that is to say, the operation will be described in which the data RD that is read from the first nonvolatile memory 11 and the write data WD that is read from the host 5 are not equal (P71); and valid bit V, in the data SA that has the lower order 13 bits of the write address WA as the address value and which is read from the first FeRAM 12a, is “1”; and the 20 bit address in which the address value of the higher-order 7 bits included in the data SA is combined with the lower order 13 bits of the address WL of the write address WA is not the same as the write address WA (P72).

The controller 34 which outputs wait signals to the host 5 (P73) while performing the matching process in which the sector which shows the sector number in the data SA (sector 2 here) using sector 15 as the buffer memory 31. That is to say, data in the sector 2 of the first nonvolatile memory 11 is linked to sector 2 and while matching with the valid data in the second FeRAM 12b, the sector 15 in the first nonvolatile memory 11 is copied (P74).

The copy operation is described as follows. When the data in sector 2 is sequentially read from the first nonvolatile memory 11, the lower order 13 bits of the 20 bit address that is assigned to the first nonvolatile memory 11 is assigned to the first FeRAM 12a and the second FeRAM 12b. In addition, in this state, if the 7 bit address value that is included in the data that is read from the first FeRAM 12a for which the valid bit V is “1” is the same as the higher-order 7 bits of the address that is assigned to the first nonvolatile memory 11, the data that is read from the second FeRAM 12b is written into the buffer memory 31 and in the other case, the data read from the sector 2 of the first nonvolatile memory 11 is written into the buffer 31.

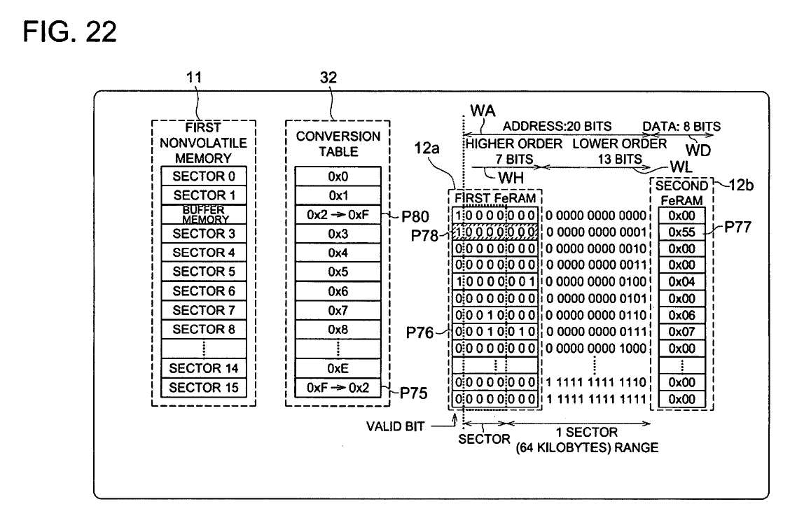

After the copy operation ends normally, the table value of the sector 15 of the conversion table 32 is converted to sector 2 (0 x 2 (H)) (FIG. 22: P75), and in the copy operation, the valid bit V corresponding to each of the data that is written in the buffer memory 31 of the first nonvolatile memory 11 from the second FeRAM 12b is cleared to “0” (P76). In addition, the value of the sector activity ratio register 14d for the sector 2 is reset to “0”.

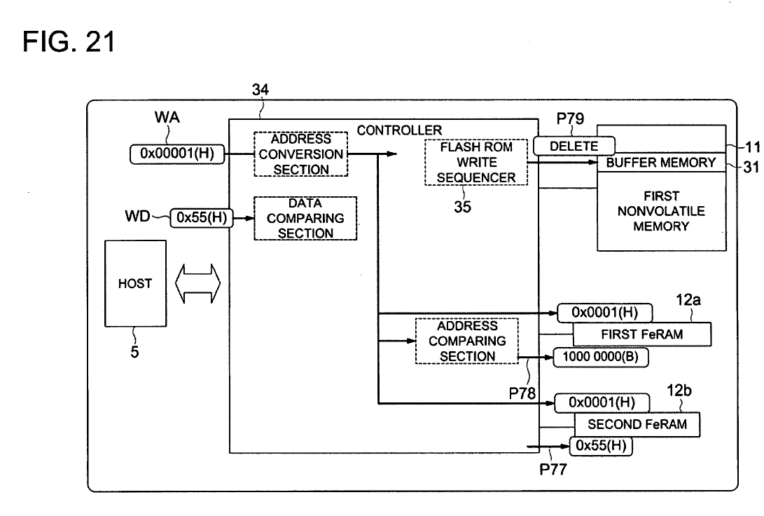

Next, the data SB in the second FeRAM 12b is rewritten to write data WD (FIG. 21 and FIG. 22: P77), and the data which includes the higher-order 7 bits of the write address WA from the host 5 and in which the valid bit V is “1” is written to the region that has the data SA for the first FeRAM 12a (P78), and the WAIT signal to the host 5 is cancelled. Subsequently, the sector 2 in the first nonvolatile memory 11 is erased by the flash ROM writing sequencer 35 of the controller 34 (P79) and at the point where the erase operation ends normally, the table values of sector 2 of the conversion table 32 is converted to that of sector 15 (0 x 0F (H)) (P80).

In this manner, by using a sector in the first nonvolatile memory 11 as the buffer memory 31, there is no need to provide buffer memory separately and the device structure is simplified. In addition, as is the case in the first embodiment, when the buffer memory 13 is provided outside the first nonvolatile memory 11, the data created in the buffer memory 13 must be rewritten in the relevant sector of the first nonvolatile memory 11, but by providing the buffer memory 31 in the first nonvolatile memory 11, the rewriting process becomes unnecessary and the processing time is reduced.

The embodiments have been explained using the drawings, but the specific structures are not to be limited by those shown in the embodiments, and modification and addition are included in the present invention provided that they do not depart from the spirit of the present invention.

For example, the capacity of the first nonvolatile memory 11 and the second nonvolatile memory 12 (first FeRAM 12a and the second FeRAM 12b) in the embodiments is one example and the capacity is not to be limited thereto.

In addition, NOR flash memory is used as the first nonvolatile memory, but NAND flash memory may also be used. In the NAND flash memory, the reading operation is done on a per-sector basis, but after reading once on a per-sector basis, the address data in the sector may be used. The buffer memory which is used in reading by sector units may be volatile memory. In addition, in the case where the NAND flash memory is used, a function for controlling defective bits or redundant bits is added.

In the embodiments, the second nonvolatile memory 12 is divided into the first FeRAM 12a and the second FeRAM 12b, but it may also be formed as a single memory.

Furthermore, in the embodiments, in the case where the data RD in the first nonvolatile memory 11 and the write data WD are not the same, the write data WD is written in the second nonvolatile memory 12 (cases 1, 2 and 3), but the write data WD may also be written in the second nonvolatile memory 12 under the condition that the write data WD is linked to the write address WA and not stored in any of the first nonvolatile memory 11 and the second nonvolatile memory 12. As a result, the writing frequency to the second nonvolatile memory 12 is also reduced.

Specifically, the write data WD is written into the second FeRAM 12b under the conditions that: the data RD read from the first nonvolatile memory 11 and the write data WD are compared (first comparison) and the results indicate that they are unequal; and valid bit V, in the data SA that has the lower order 13 bits of the write address WA as the address value and which is read from the first FeRAM 12a, is “1”; the 20 bit address combined with the address value of the higher-order 7 bits included in the data SA is the same as the write address WA; the data SB read from the second FeRAM 12b and the write data WD are compared (second comparison) and the results indicate that they are unequal.

It is to be noted that the first comparison and the second comparison described above may be performed simultaneously or consecutively. In the latter case, if the first nonvolatile memory 11 is the NOR type, the first comparison is performed first and when the results indicate that they are not equal, the second comparison is performed. On the other hand, in the case where the first nonvolatile memory 11 is the NAND type, because the reading of the data is done on a per-sector basis and data reading is time consuming, the second comparison which compares the data SB that is read from the second FeRAM 12b and the write data WD is preferably performed first and the first comparison is only performed when they are not equal, and as a result, the processing time is reduced.

Also, in this embodiment, when the write data WD and the write address WA are linked and stored in the second nonvolatile memory 12, a portion of the write address WA (the lower order 13 bits) is used as the access address for the second nonvolatile memory 12, and the address for the remaining 7 bits and the write data WD are stored in the second nonvolatile memory 12 (12a and 12b), but all the bits in the write address WA may be linked with the write address WD and stored in the second nonvolatile memory 12.

FeRAM is used as the second nonvolatile memory 12 and the buffer memory 13, but other types of memory may be used provided that they are non-volatile, random access is possible, and a rewrite limit frequency that is higher than that required for the product can be secured.

According to the non-volatile memory system and method for controlling non-volatile memories of this invention, all of the following conditions are satisfied: no batteries are used and data storage is possible indefinitely; random write access is possible; there are no limits on practical writing frequency; and bit price is low.

What is claimed is:

1. A nonvolatile memory system comprising:
a first nonvolatile memory in which data writing is limited to writing data on a per-sector basis;
a second nonvolatile memory to which random access is possible and is for storing a portion of data to be stored in the first nonvolatile memory; and
a controller for controlling data read and write operations for the first nonvolatile memory and the second nonvolatile memory;
wherein when the controller receives a write command for writing write data in the first nonvolatile memory from an external device, the controller writes the write data in the second nonvolatile memory linking to a write address that was specified by the write command under a condition that the same data as the write data designated to be written by the write command is not stored in a region in the first nonvolatile memory corresponding to the write address specified by the write command, and the controller performs a matching process, in which data in the second nonvolatile memory is moved in the first nonvolatile memory on the per-sector basis when a predetermined condition is satisfied.

2. A nonvolatile memory system comprising:
a first nonvolatile memory in which data writing is limited to writing data on a per-sector basis;
a second nonvolatile memory to which random access is possible and is for storing a portion of data to be stored in the first nonvolatile memory; and
a controller for controlling data read and write operations for the first nonvolatile memory and the second nonvolatile memory;
wherein when the controller receives a write command for writing write data in the first nonvolatile memory from an external device, the controller writes the write data in the second nonvolatile memory linking to a write address that was specified by the write command under a condition that the same data as the write data designated to be written by the write command is not stored in a region in the first nonvolatile memory corresponding to the write address specified by the write command nor in a region in the second nonvolatile memory, and the controller performs a matching process, in which data in the second nonvolatile memory is moved in the first nonvolatile memory on the per-sector basis when a predetermined condition is satisfied.

3. The nonvolatile memory system of claim 2, wherein the controller checks whether the same data as the write data designated to be written by the write command is not stored in the first nonvolatile memory before checking whether the same data as the write data designated to be written is not stored in the second nonvolatile memory.

4. The nonvolatile memory system of claim 2, wherein the controller checks whether the same data as the write data designated to be written by the write command is not stored in the second nonvolatile memory before checking whether the same data as the write data designated to be written is not stored in the first nonvolatile memory.

5. The nonvolatile memory system of claim 1, wherein the controller manages an activity ratio of the second nonvolatile memory on the per-sector basis of the first nonvolatile memory and controls the matching process based on the activity ratio.

6. The nonvolatile memory system of claim 5, wherein the controller performs the matching process for a sector in which the activity ratio exceeds a predetermined threshold value.

7. The nonvolatile memory system of claim 1, further comprising;
a nonvolatile buffer memory having a capacity for more than one sector of the first nonvolatile memory,
wherein the controller writes data for one sector in the nonvolatile buffer memory in the matching process and the data for one sector corresponds to data in the first nonvolatile memory that reflects the data in the second nonvolatile memory.

8. The nonvolatile memory system of claim 7, wherein the controller uses an arbitrary sector in the first nonvolatile memory as said nonvolatile buffer memory and converts address information to be assigned to the first nonvolatile memory so that a sector subject to the matching process and the sector assigned to the nonvolatile buffer memory are exchanged after performing the matching process.

9. A method of controlling memories including a first nonvolatile memory in which data writing is limited to writing data on a per-sector basis and a second nonvolatile memory to which random access is possible and is for storing a portion of data to be stored in the first nonvolatile memory, the method comprising:
receiving a write command for writing write data in the first nonvolatile memory;
writing the write data in the second nonvolatile memory linking to a write address that was specified by the write command under a condition that the same data as the write data designated to be written by the write command is not stored in a region in the first nonvolatile memory corresponding to the write address specified by the write command; and
performing a matching process, in which data in the second nonvolatile memory is moved in the first nonvolatile memory on the per-sector basis when a predetermined condition is satisfied.

10. A method of controlling memories including a first nonvolatile memory in which data writing is limited to writing data on a per-sector basis and a second nonvolatile memory to which random access is possible and is for storing a portion of data to be stored in the first nonvolatile memory, the method comprising:
receiving a write command for writing write data in the first nonvolatile memory;
writing the write data in the second nonvolatile memory linking to a write address that was specified by the write command under a condition that the same data as the write data designated to be written by the write command is not stored in a region in the first nonvolatile memory corresponding to the write address specified by the write command nor in a region in the second nonvolatile memory; and
performing a matching process, in which data in the second nonvolatile memory is moved in the first nonvolatile memory on the per-sector basis when a predetermined condition is satisfied.

11. The method of claim 10, wherein the writing step includes;
checking whether the same data as the write data designated to be written by the write command is not stored in the first nonvolatile memory before checking whether the same data as the write data designated to be written is not stored in the second nonvolatile memory.

12. The method of claim 10, wherein the writing step includes;
checking whether the same data as the write data designated to be written by the write command is not stored in the second nonvolatile memory before checking whether the same data as the write data designated to be written is not stored in the first nonvolatile memory.

13. The method of claim 9, further including; managing an activity ratio of the second nonvolatile memory on the per-sector basis of the first nonvolatile memory and wherein the performing step is executed based on the activity ratio.

14. The method of claim 13, wherein the matching process is performed for a sector in which the activity ratio exceeds a predetermined threshold value.

15. The method of claim 9, wherein the method further controls a nonvolatile buffer memory having a capacity of more than one sector of the first nonvolatile memory, and wherein the performing process includes writing data for one sector in the nonvolatile buffer memory in the matching process and the data for one sector corresponds to data in the first nonvolatile memory that reflects the data in the second nonvolatile memory.

16. The method of claim 15, further including;
using an arbitrary sector in the first nonvolatile memory as the non volatile buffer memory; and
converting address information to be assigned to the first nonvolatile memory so that a sector subject to the matching process and the sector assigned to the nonvolatile buffer memory are exchanged after performing the matching process.
